(19) United States
(12) Patent Application Publication
(10) Pub. No.: US 2011/0215933 A1
(43) Pub. Date: Sep. 8, 2011

(54) SYSTEMS AND METHODS FOR ELECTRONIC REMINDERS

(75) Inventors: Charles M. Darling, IV, Houston, TX (US); Jenny E. Freeman, Weston, MA (US); Kareem S. Reda, Cambridge, MA (US); James F. Toy, IV, Weston, MA (US); Matthew G. Brown, Freehold, NJ (US); Cameron MacKenzie, Newton, MA (US)

(73) Assignee: TxtFLASH LLC, Houston, TX (US)

(21) Appl. No.: 13/039,022

(22) Filed: Mar. 2, 2011

Related U.S. Application Data
(60) Provisional application No. 61/309,619, filed on Mar. 2, 2010.

(51) Int. Cl. G08B 23/00

(52) U.S. Cl. 340/573.1

(57) ABSTRACT

A method of automatically reminding an attendee of an appointment and a system implementing the method are disclosed. The method includes one or more computers implementing: obtaining an appointment reference from a registrant, predicting the likely behavior of the attendee, transmitting at least one reminder to the attendee based on the predicted likely behavior of the attendee, receiving a response from the attendee; and notifying the registrant of the response received from the attendee. The likely behavior of the attendee is based on at least one of past behavior and compiled demographic behavior.

### REFERENCE TO RELATED APPLICATIONS

This application claims priority to U.S. Provisional Application No. 61/309,619 entitled “Systems and Methods for Electronic Reminders” and filed Mar. 2, 2010, the entirety of which is hereby incorporated by reference.

### BACKGROUND

1. Field of the Invention

The invention is directed to systems for utilizing electronic message reminders and methods of their use and, in particular, methods and systems of sending, receiving, responding to, capturing, archiving and analyzing electronic messages.

2. Background of the Invention

Many enterprises rely on appointments and/or reservations (hereinafter “appointments”) to successfully run their business. For example, medical professionals, legal professionals, cosmetologists, accountants, restaurants, hotels, clergy and churches, clubs, societies, organizations, real estate agents, and other managers all use appointments as a part of normal business. Customers, clients, business associates, members, and/or patients (hereinafter “customers”) showing up late to events or meetings or missing appointments, events or meetings can cause problems with the fluidity of running these businesses or impose additional costs on them.

Over time, several methods of providing reminders to customers have developed. Current methods that have been commonly used are often only part of an appointment reminder solution. The simplest is an appointment reminder card handed out at the office when a customer makes an appointment. Shortcomings of this method include the responsibility of the customer to retain the card, the inability to take advantage of any appointment management technology the customer may have available (such as a mobile phone or e-calendar), or the failure of the customer to focus on the appointment and/or register its existence on the medium in which it is recorded, thereby relying on the customer to recall or record the appointment; also, these reminders generally require the customer to be on-site when making an appointment. Reminder postcards resolve only the last of these shortcomings but the former still apply. Better is a phone-call system where the customer receives a call prior to the appointment. However, these calls may be received by a customer's voicemail system (if it exists) and, therefore, may not allow the customer to confirm the appointment. If the customer does receive the call, typically (s)he may only confirm or cancel the appointment. Typically, customization of these calls is a difficult process involving manpower, even in cases where the facility uses an electronic appointment scheduling system. Automated e-mails tend to serve as notifications, but, as above, typically do not allow the customer to respond, may get sent to spam, or may not be entered by the customer into his preferred device. One-way text message, also known as SMS (short message service), reminders have a good chance of reaching the customer wherever he or she is, but again do not facilitate two-way communication. Also, depending on the timing, these messages may be sent too early and a customer may miss the appointment anyway, or too late and, if the customer cancels, the facility may not be able to fill the appointment block in time. Therefore, a system that both incorporates an automated feature and allows for two-way communication and improves customer compliance by increased customer attendance in a complete appointment management system is highly desirable.

### SUMMARY OF THE INVENTION

The present invention overcomes the problems and disadvantages associated with current strategies and designs and provides new systems and methods of sending, receiving, responding to, capturing, archiving and analyzing electronic messages and customer behavior, as well as creating a self-teaching system for iterative improvement of the reminder system.

One embodiment of the invention is directed to a system for sending, receiving, capturing and storing electronic message reminders and responses thereto. The system has features to create a permanent record of sender and receiver in a secure, confidential format. The system provides reminders as specified by the appointment manager (“manager”), be it an assistant, a lawyer, physician, manager, clergy, boss, associate or other person managing the appointment system or arranging the appointment with specified timing and content. The messages may be sent to a computer, telephone, or mobile telephone.

In one embodiment the system provides a single reminder or a series of reminders for an appointment, event, transaction or test. Requirements for customer actions are included in the message, such as address of appointment, medication to be taken or avoided, diet modifications, purpose of appointment or meeting, or other information.

In one embodiment, the system uses statistical analyses of intra-customer behavioral information and/or inter-customer information (e.g. behavioral information derived from multiple customers in the same or similar demographics) to determine the timing of reminders relative to the time of the appointment or test.

In one embodiment, the system provides a single or a series of notifications of new availability for the transactional event, an appointment, meeting or test that the customer has indicated is desired (i.e., a waiting list feature).

In one embodiment, the system uses customer demographic data to send a notification suggesting the scheduling of a transactional event, appointment, meeting or test, such as a suggestion to schedule a colonoscopy for a patient who has just turned 40.

In one embodiment, the system stores all communication records and customer demographic and behavior information for future documentation and analysis. The system may be compliant with any applicable regulatory privacy standards, including HIPAA standards, and other common security standards and provides data encryption capabilities. Storage is in a non-corruptible format (read-only).

In one embodiment, analyses include (but is not limited to) customer demographics, manager preference, tests, time from scheduling to appointment, current and previous no-show, customer appointment history, type of appointment, history of tardiness, and distance of customer from site of appointment or event. Results of the analysis of these data can assist, for example, in planning patient scheduling in medical care settings or client meetings for attorneys. By way of further example, a predicted no-show rate can be displayed at the time of booking the appointment for a specific patient such as a 65 year old male with diabetes for a 3 month office visit or a 35 year old woman with a family history of breast cancer for a mammogram. Aggregate data is also useful for the provider in terms of scheduling. Similarly, for an attorney, client reliability for attendance of a senior citizen client on estate matters can be shown. A new customer is contacted based on previous aggregate data related to his individual profile and refined based on a growing database and on his performance in keeping appointments. Priority appointment scheduling may be provided based on customer appointment-keeping behavior with sooner or prime-time appointments made available for customers compliant with appointment attendance.

In one embodiment, the reminder can be for patient therapy such as a medication reminder or other action. The system analyzes responses to the messages sent and patient action, and in an iterative, self-teaching fashion, the system optimizes patient contact timing and methods to enhance compliance.

In one embodiment, the system interfaces with an electronic health, legal or other transactional with business record.

In one embodiment, the system provides an automatic interface to an existing wait list to automatically reschedule an appointment where the customer does not attend the appointment or the response to the reminder is that the customer will not be coming.

In one embodiment, the controller is tied to a computer or web page, giving the manager the ability to affect all controls from that platform.

In one embodiment, reminders in advance of an appointment are initiated on confirmation by the customer that he will be able to make the appointment. Because of advanced storage and analysis capabilities, for example, in the medical environment, medication reminders can be followed by request for diagnostic procedure such as blood pressure measurement or blood glucose measurement. The self-teaching system is customer specific for reminders such as health maintenance appointments or prescription refills. In another iteration, the self-teaching algorithm is based on analysis of an aggregate of data from many customers and their preferences and performance. Algorithms mining this data trend on customer subsets or the entirety of the dataset. Similar analogous deviations can be seen in the legal, accounting, business, religious and other environments.

One embodiment of the invention is directed to methods of automatically reminding an attendee of an appointment. The method includes the steps of obtaining an appointment reference from a registrant, predicting the likely behavior of the attendee, wherein the likely behavior of the attendee is based on at least one of past behavior of the attendee and compiled demographic behavior of multiple attendees, transmitting at least one reminder to the attendee based on the predicted likely behavior of the attendee, receiving a response from the attendee, and notifying the registrant of the response received from the attendee.

In the preferred embodiment, at least one of the transmitting and receiving devices is via at least one of a computer, e-mail, a land telephone, a cellular phone, a personal digital assistant (“PDA's”), a smartphone, or another portable device with communications capabilities. Preferably, the method further comprises maintaining information related to the attendee and the registrant in a secure and confidential format.

Preferably the at least one reminder is transmitted to a designated group, subgroup, category, subcategory, or individual. In each instance, the manager can specify the group, subgroup, category, subcategory or individual to be contacted. The attendee may be given the option to opt into or opt out of the system and to determine the groups, subgroups, categories, or subcategories that the attendee wishes to be a part of.

In the preferred embodiment, the response from the attendee is at least one of confirming the appointment, canceling the appointment, and rescheduling the appointment. The appointment may be a time to take an action. The action is preferably at least one of taking medication, taking a test, and checking in with a service, office or specified individual, or can be attendance at a meeting or event. The response may be at least one of confirming an action, such as attending a meeting, medication was taken, test results, and location update. The location update is preferably via a GPS application.

The method preferably further comprises automatically generating a notification to a designated recipient in the event an expected response is not received. The method may also further comprise storing all communications records, responses, or results, and demographic data to enable future documentation and analysis.

In a preferred embodiment, the method further comprises recording at least one of attendee or registrant preferences. The step of predicting the likely behavior of the attendee preferably comprises at least one of predicting likelihood of missing an appointment, likelihood of being late to an appointment, and likelihood of rescheduling an appointment. The method may generate an automatic response to reschedule a missed appointment or elicit another response.

Another embodiment of the invention is directed to a system for automatically reminding an attendee of an appointment. The system comprises a processor, a transceiver in communication with the processor, and software executing on the processor. The software obtains an appointment reference from a registrant, predicts the likely behavior of the attendee, wherein the likely behavior of the attendee is based on at least one of past behavior of the attendee and compiled demographic behavior of multiple attendees, transmits at least one reminder to the attendee based on the predicted likely behavior of the attendee, receives a response from the attendee, and notifies the registrant of the response received from the attendee.

In the preferred embodiment, the transceiver at least one of transmits and receives via at least one of a computer, e-mail, a land telephone, a cellular phone, a personal digital assistant (“PDA's”), a smartphone, or another portable device with communications capabilities. The software preferably maintains information related to the attendee and the registrant in a secure and confidential format.

Preferably, at least one reminder is transmitted to a designated group, subgroup, category, or subcategory, or member thereof. The attendee is preferably given the option to opt into or opt out of the system and to determine the groups, subgroups, categories, or subcategories that the attendee wishes to be a part of.

In the preferred embodiment, the response from the attendee is at least one of confirming the appointment, canceling the appointment, and rescheduling the appointment. The appointment may be a time to take an action. The action is preferably at least one of taking an action, such as attending a meeting, taking a medication, taking a test, and/or checking in with a service office, or specified individual, or can be attendance at a specified meeting or event. The response is preferably at least one of confirming medication was taken, test results, and location update. Preferably, the location update is via a GPS application.

The software preferably automatically generates a notification to a designated recipient in the event an expected response is not received. Preferably, the software stores all communications records, responses, or results, and demographic data to enable future documentation and analysis. In the preferred embodiment, the software records at least one of attendee or registrant preferences.

Predicting the likely behavior of the attendee preferably comprises at least one of predicting likelihood of missing an appointment, likelihood of being late to an appointment, and likelihood of rescheduling an appointment. The software preferably generates an automatic response to reschedule a missed appointment or elicit another response.

Another embodiment of the invention is directed to computer readable media for automatically reminding an attendee of an appointment. The media causes a computer to obtain an appointment reference from a registrant, predict the likely behavior of the attendee, wherein the likely behavior of the attendee is based on at least one of past behavior of the attendee and compiled demographic behavior of multiple attendees, transmit at least one reminder to the attendee based on the predicted likely behavior of the attendee, receive a response from the attendee, and notify the registrant of the response received from the attendee.

Another embodiment of the invention is to have the capability to have the manager directly input a notification, reminder, or information to a group, subgroup, category, subcategory, or individual member thereof, from a controlling terminal, which may be a computer, cellular phone, including smart phones, personal digital assistant (“PDA”) or other device capable of sending and reviewing electronic data.

Preferably, at least one of the transmitting and receiving is via at least one of a computer, e-mail, a land telephone, a cellular phone, a personal digital assistant (“PDA's”), a smartphone, or another portable device with communications capabilities. In the preferred embodiment, the media further causes the computer to maintain information related to the attendee and the registrant in a secure and confidential format.

Preferably, the at least one reminder is transmitted to a designated group, subgroup, category, or subcategory. The attendee may be given the option to opt into or opt out of the system and to determine the groups, subgroups, categories, or subcategories that the attendee wishes to be a part of.

In a preferred embodiment, the response from the attendee is at least one of confirming the appointment, canceling the appointment, and rescheduling the appointment. The appointment may be a time to take an action. The action is preferably at least one of taking an action, such as attending a meeting, taking a medication, taking a test, and checking in with a service, office or specified individual. The response is preferably at least one of confirming attendance will or has occurred, the medication will be or has been taken, test results, and location update. Preferably the location update is via a GPS application if the communication device has such capability.

In a preferred embodiment, the media further causes the computer to automatically generate a notification to a designated recipient in the event an expected response either is not received. The media preferably further causes the computer to store all communications records, responses, or results, and demographic data to enable future documentation and analysis.

The media preferably further causes the computer to record at least one of attendee or registrant preferences. Predicting the likely behavior of the attendee comprises may at least one of predicting likelihood of missing an appointment, likelihood of being late to an appointment, and likelihood of rescheduling an appointment. Preferably, the media further causes the computer to generate an automatic response to reschedule a missed appointment or elicit another response.

Other embodiments and advantages of the invention are set forth in part in the description, which follows, and in part, may be obvious from this description, or may be learned from the practice of the invention.

### DESCRIPTION OF THE DRAWINGS

The invention is described in greater detail by way of example only and with reference to the attached drawings, in which:

FIG. 1 is a schematic of an embodiment of the system of the invention.

FIGS. 2 through 4 are flow charts of the differing embodiments of the invention.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

The basic platform provides secure data management services for instant messaging (IM) (e.g., AIM, Yahoo Messenger), chats, and short messaging services (SMS), where the manager can control the system through or device capable of receiving and transmitting communications, including a computer, server, smart phone, personal digital assistant, or other such electronic platform. The basic platform creates the ability to quickly and simply save, manage, search and then forward the data from across all networks, clients, and devices. The invention provides recording and archival systems to manage appointments for professionals, including doctors, attorneys, clergy and accountants, and other appointment driven industries, providing data mobility, synchronization, and transport across multiple communications systems and multiple text-based mediums, including SMS, IM, and Email. In the realm of patient care and patient management, client representation, or religious ministering the invention has the capability to provide similar enhanced services.

One embodiment provides a unified database of communication data, facilitating efficient data analysis and data-driven applications. The core functionality supports multiple data standards to provide forward compatibility and easy integration with legacy systems. This reduces the total cost and risk of deploying new communications platforms. The core functionality ports data to multiple different data standards. The basic system eliminates many data platform lock-in concerns. Due to the large volume of messages sent between SMS and IM, one embodiment of the invention has the capability to build and manage extremely large databases. One embodiment allows for a high level of compression, which ensures cost effective storage.

Because communication data is sensitive by nature, the invention addresses the privacy and security needs of its users and clients. One embodiment explicitly focuses on platform-agnostic communication data management. By leveraging APIs and relevant standards, the invention eliminates the data barriers that divide common communication platforms.

In one embodiment of the device, solutions are developed for necessary connectors and coordination affected with existing IT management systems to ensure that the communications database accommodates current needs and can scale according to the strategic goals of the organization.

One embodiment uses API's and provides the necessary connectors to create a unified real-time record of text communications. Data from various communications systems and projects are imported into a central database, and data schemas normalized and structured. These preparations are implemented in such a way as to facilitate future implementations such as more sophisticated statistical analysis, the formulation of specific research questions and the implementation of data driven applications, scripts, and utilities.

One embodiment utilizes new mediums of communication, such as Instant Messaging or Chats, or may be expanded in scope. One embodiment enables the implementation of statistical packages to provide quantitative oversight of text based communications activities, delivering a unified and quantitative perspective on communications across all supported text mediums. This data aids in the implementation, analysis and comparison of data for future pilot projects.

One embodiment provides a Mobile Self-care guidance system: A Physician-side control panel allows the PCP to customize a glucose monitoring schedule for the patient. At the appropriate time, an SMS is sent to the patient, reminding him to take a blood glucose measurement. By responding to the SMS with the results of the test (usually just a number) the patient automatically records his results. The data is archived and made accessible to the PCP and the patient via a web console. The patient can view summary data and trend analyses from the website. The PCP can also review the data and send suggestions to the patient via SMS and email. The PCP can also receive notifications when patient compliance drops off. The data can be mined, together with other medical records to identify risk patterns and facilitate remediation by the PCP. This system would provide a mobile, secure, convenient self-care scheduling and record keeping system that requires no patient side software or installation. Security could be enhanced with patient side software if necessary. It may also facilitate reward structures that encourage cost saving behavior. For instance, routine testing could be rewarded offsetting part of the mobile service charges.

The invention includes, SMS-based appointment confirmation, SMS-based appointment reminders (day of), tardiness notification (i.e., when the customer expects to be late, he or she can notify the office by sending a text, allowing re-sequencing of patients in the queue), SMS prescription-ready alerts (e.g., to notify the patient when a prescription has been filled), waiting room alerts (e.g., similar to the queuing systems used in some restaurants, the customer's phone could be used to alert the customer when the manager is ready for the customer), emergency room alerts (e.g., alerts that allows a patient or family member to alert the hospital of an impending arrival at the emergency room). Emergency room alerts may speed the check in process and provide additional time for the emergency staff to prepare. Such a system would provide peace of mind to expectant mothers or the chronically ill.

In one embodiment, the fundamental architecture is designed to facilitate analysis. Models can then be implemented to accurately identify and predict a customer's future behavior and correlate across customers. The algorithms used in the predictive engines are designed to increase accuracy with increasing data/user volumes and to correct for a high degree of unstructured or incorrectly formatted inputs. This allows for the compounding value of past and future research data sets and greatly increases the capacity for future research into understanding and modeling of relevant communications.

A problem in the art capable of being solved by the embodiments of the present invention is providing an appointment reminder service. It has been surprisingly discovered that a two-way electronic based messaging system improves appointment attendance and appointment booking rates.

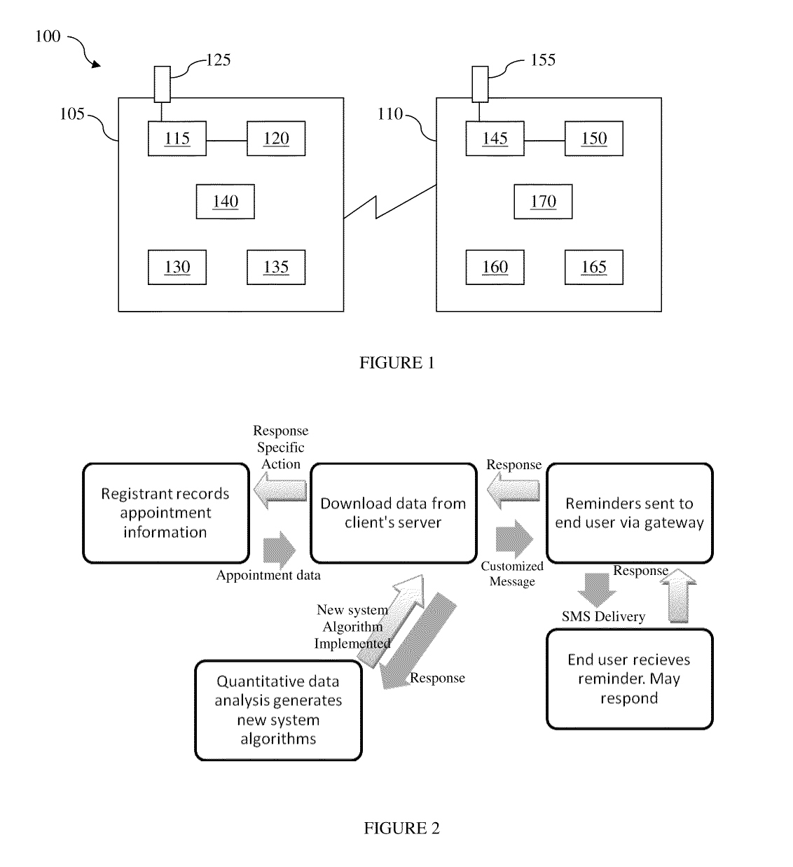

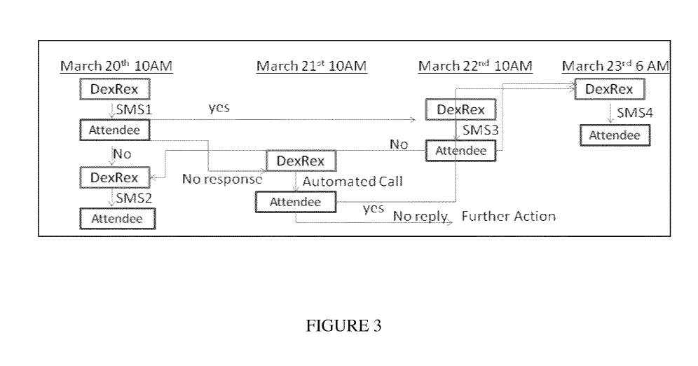

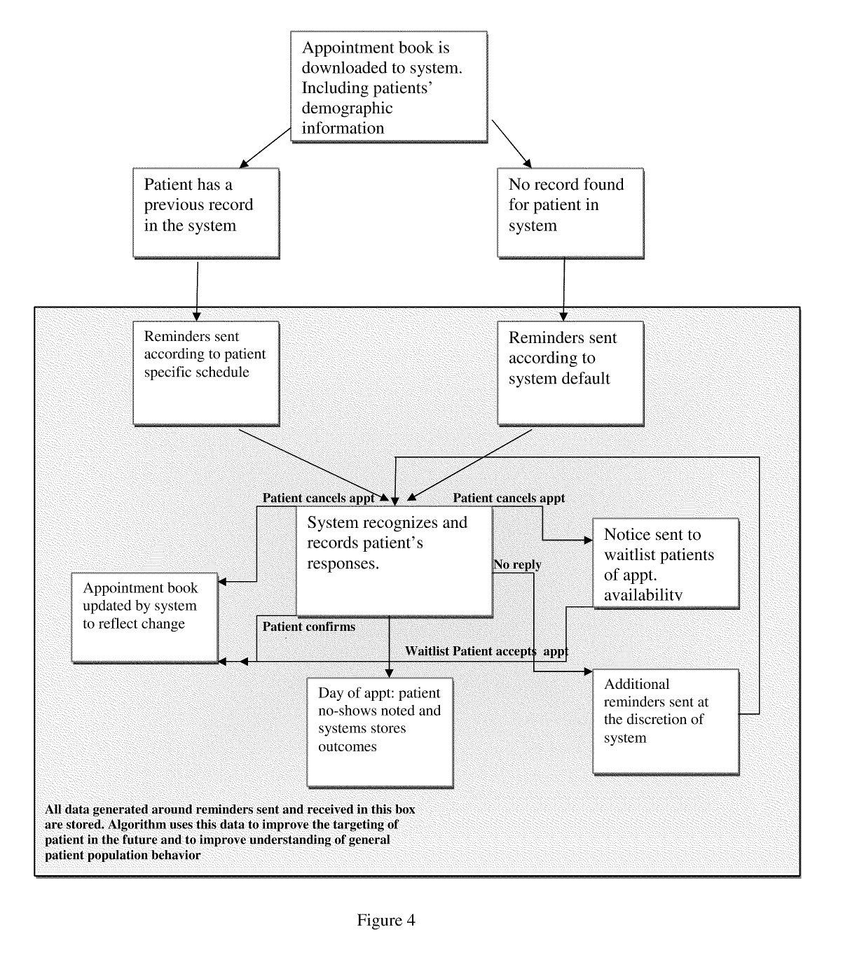

FIG. 1 is a schematic of an embodiment of a system 100 of the invention. System 100 includes at least one client device 105 and at least one server 110. In the preferred embodiment, client device 105 and server 110 are in wireless communication with each other. For example, client device 105 and server 110 can communicate via, radio frequency (RF), LAN networks, WAN networks, WiFi, WiMax, Voice Over IP (VOIP) networks, satellite networks, Global System for Mobile Communications (GSM) networks, General Packet Radio Service (GPRS) networks, Code Division Multiple Access (CDMA) networks, Evolution-Data Optimized (EV-DO) networks, Enhanced Data Rates for GSM Evolution (EDGE) networks, 3GSM networks, Digital Enhanced Cordless Telecommunications (DECT) networks, Digital AMPS (IS-136/TDMA) networks, and Integrated Digital Enhanced Network (iDEN) networks. However, in other embodiments, mobile device 105 and server 110 can communicate over wired networks.

Client device 105 is a device capable of sending and receiving messages remotely. For example, client device 105 can be a personal computer, a workstation, a mobile telephone, a personal digital assistant (PDA), a laptop computer, a smartphone, an iPhone®, a Blackberry®, an Android® device, or a WiFi enabled device. Each client device 105 has a processor 115. The functions of processor 115 can be provided by a single processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed herein, and random access memory (RAM) for storing results. Very large scale integration (VLSI) hardware embodiments, as well as custom VLSI circuitry in combination with a general purpose DSP circuit, may also be provided.

Processor 115 is in communication with a data storage device 120. Data storage device 120 is preferably a semiconductor-based memory (i.e. a flash memory device). However, other types of data storage devices can be used, for example, magnetic storage devices and optical storage devices. In the preferred embodiment, data storage device 120 is a fixed storage device. However, in other embodiments removable storage devices can be used. Data storage device 120 can retain data necessary for the functioning of client device 105, incoming or outgoing message data, and/or software that can be executed by processor 115. Additionally, processor 115 is in communication with a transmitter 125. Transmitter 125 is a device capable of transmitting messages from client device 105 to server 110. In the preferred embodiment, transmitter 125 is capable of bi-directional communications. In the preferred embodiment, transmitter 125 is the same device client device 105 uses to send and receive messages. However, in other devices, transmitter 125 is a separate device. Transmitter 125 can be capable of communication over one or more of the above mentioned networks. Transmitter 125 can include a network interface card. The incoming and outgoing network traffic routed through the network interface card is preferably monitored by a network monitor preferably at the Data Link Layer.

Other aspects of client device 105 can include a power source 130, an input device 135, and an output device 140. Power source 130 is a device capable of powering the client device 105. For example, power source 130, can be a battery, a solar cell, AC or DC power sources, biological power sources, fly wheels, wind turbines, and kinetic motion power sources. Input device 135 is a device capable of providing information to the client device 105. For example, input device 135 can be a key pad, a touch screen, and/or a voice activated device. Output device 140 is a device capable of providing information to a user. For example, output device 140 can be a screen, a printer, a sound producing device, and/or a vibration producing device.

Server 110 is a device capable of receiving data from client device 105, structuring the data, storing the data, and outputting the data as required. For example, server 110 can be a personal computer, a network of remotely connected computing devices (e.g. cloud computing), a series of computing devices connected over a network (e.g. a company network), and/or a portable computing device. In a preferred embodiment each component running on server 110 would actually be broken out to run on its own server. In another embodiment there are multiple servers 110. However, in other embodiments there can be just one server 110. In the preferred embodiment, server 110 has a processor 145. The functions of processor 145 can be provided by a single processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Processor 145 is in communication with a data storage device 150. Data storage device 150 is preferably a device able to store large amounts of data, for example, semi-conductor storage devices, magnetic storage devices, and/or optical storage devices. In the preferred embodiment, data storage device 150 is a fixed storage device. However, in other embodiments removable storage devices can be used. Data storage device 150 can retain data necessary for the functioning of server 110, incoming or outgoing message data, and/or software that can be executed by processor 145. In the preferred embodiment there is one data storage device 150. However, in other embodiments, there is more than one data storage device 150. Additionally, processor 145 can be in communication with a receiver 155. Receiver 155 is a device capable of receiving transmissions from client device 105. In the preferred embodiment, receiver 155 is capable of bi-directional communications. Receiver 155 can be capable of communication over one or more of the above mentioned networks.

Other aspects of server 110 can include a power source 160, an input device 165, and an output device 170. Power source 160 is a device capable of powering the server 110. For example, power source 160, can be a battery, a solar cell, AC or DC power sources, biological power sources, fly wheels, wind turbines, and kinetic motion power sources. Input device 165 is a device capable of providing information to server 110. For example, input device 165 can be a key pad, a mouse, a touch screen, and/or a voice activated device. Output device 170 is a device capable of providing information to a user. For example, output device 170 can be a screen, a sound producing device, a printer, an emailing device, and/or a vibration producing device.

There are several methods of providing reminders to customers and other persons relative to appointments. The fundamental components of such a system entail: a client, server, SMS dispatch system, management device, and an event infrastructure which provides a basis for an action. The fundamental user roles include a registrant who sets up an appointment in the system, and an attendee who is notified of the appointment to be attended or a task to be performed. At times, these roles are embodied in the same person, two persons, or many people. Additionally, while the term appointment is used throughout, an “appointment” may be a reminder to take an action. Such action may include, but is not limited to, taking or refilling medication, taking a test (i.e. medical procedure), checking-in, sending flowers, checking in with a client, or other action.

Consider the most fundamental action derived from an event: a customer has been registered for an appointment, the appointment registrant delineates a notification time or a default notification time is set. As the difference between the current time and the notification time approaches zero the notification is dispatched from the appointment system. The dataflow originates when the appointment is stored in the registrant's appointment system. In one embodiment, the appointment is the fundamental data unit to the system. Each subsequent event and action is contingent upon this information.

In one embodiment, the attendee is the fundamental data unit. In its most basic form, this data structure contains a name, number and other contact information much like a contact card. This can be used at the discretion of the system. The reason the appointment isn't a required component of the data structure is due to the fact that a contact may be placed on a waitlist to fill a given appointment time. This is a specification of the most basic functionality of the system.

The system also utilizes customer information to distinguish the characteristics of notifications useful to certain customers. For example, a type one diabetic should not receive the same priority level notifications as a patient with breast cancer. The system is designed to learn about customers and adapt notification algorithms to make educated decisions that are appropriate to the customer's lifestyle and needs. For example, a 23-year-old male does not necessarily need to be reminded to make a new appointment for a mammography as a woman who just turned 50 might, since missing a mammography is usually more important to a woman than a man.

Several abstractions of statistical information are preferably gathered by the system. Each time an appointment is scheduled and reminders are sent, the data is stored and analyzed. There is individual data that is aggregated and compiled into useful models for an individual customer. Demographic information for the entire population such as, age, illness, complication, etc. is also available for analysis. The accumulated information creates the intelligence that exists by combining the two groups is analyzed in order to extrapolate for future individual and existing customers and customer populations. Iterative statistical analysis and proprietary algorithms provide the base for a self-teaching system.

The technical facilities (detailed herein) make determinations about message timing and content. Possible examples of system require several core components: the service from which the notification event is sent and received, self-teaching algorithms, and the data. In one embodiment the service takes the form of the SMS dispatch system that is compatible with any cell phone that is SMS capable. In one embodiment the service can be a native Smartphone application; this would be specialized based upon the specific device (BlackBerry, iPhone, Android, etc). A specialized Smartphone application provides the processing (self-teaching) algorithms with more data, for example location based services that generate geographic location data (e.g. weather and/or traffic conditions) based on the device GPS. The service is directly connected to the processing (self-teaching) algorithms. The processing algorithms are hosted on a server and derive their information from the user responses provided by the notification service. A transport protocol must exist in order to get the information from the notification service to the processing algorithms. In one embodiment this transport method is a SOAP protocol implementation, this method relies upon XML and the Application Layer most notably RPC and HTTP. In one enumeration this transport method is a JSON implementation standardized in RFC 4627; it is sent over JSON-RPC. This method is particularly useful for ensuring serialization. The final transport method is simple XML over HTTP (XML-RPC), which is basic and prevalent. All of the enumerated transport methods can be encrypted in HIPAA compliant TLS/SSL cryptographic protocols or other relevant protocols to ensure sensitive information security. The final component of the system is the data and storage components. In order to run the self-teaching algorithms there is preferably a data set with which notifications of any kind are generated. This “original” data is provided by a subset of a records database. The self-teaching algorithms generate databases in order to keep track of statistical information to guide future decision-making. In one enumeration this takes the form of {MySQL, PostgreSQL, etc}. Data that is under HIPAA or other authority may be stripped of personal identifiers and assigned randomly generated identifiers for security purposes and to allow statistical analysis. This data may also be encrypted by randomly generated encryption keys to ensure all sensitive data is useless once it leaves the system, thus rendering the data secure and confidential.

The learned behavior of the system includes, but is not limited to: specificity related to a statistics based on specific demographics, frequency of notifications, modifications to timing of notifications (relative to pre-set notification times or to the appointment time), offerings to make new appointment types appropriate to any one or more demographic(s), location-based notifications based on geographic location of the device or the address of the appointment, modification to appointment preparation or therapy-based reminders, and customer preferences (such as physician, facility, appointment times, etc.).

Each time that a customer appointment is created, the system analyzes the individual customer's behavior (i.e. did the customer show up? How many contact attempts did it require before customer to respond? Were there any other factors, such as weather, traffic, the fact that the customer had a long wait at a previous appointment?). These results are stored for the individual customer as well as aggregated with other customer data which is analyzed and organized by demographics. Trends are taken from the data analysis and the system updates its “rules” for certain types of customers by demographics such as gender, age, and location, and disease status. For example, a customer John Doe is given an appointment on March 30^{th} for June 12^{th}. The system reviews John Doe's information; the system flags John as high risk to miss appointment. The system sends an additional reminder to insure John Doe keeps his appointment. When June 12^{th} arrives, the system notes whether new algorithms were successful at reminding John to come to his appointment, and the algorithm through self-learning, makes any required adjustments. As another example, Jane Doe is a new patient to a practice. Her first appointment is scheduled on the May 20^{th} for June 14^{th}. The system downloads Jane's demographic information (age, sex, location, disease state, and appointment type) this information is cross referenced with a database of similar patients and a schedule of reminders is developed for Jane. She is contacted accordingly and results are noted and stored in Jane's profile both for system behavior modification and to improve Jane's attendance in the future. In one embodiment the registrant has an appointment management software which communicates directly with server.

Step by step description of one embodiment of the basic system:
1. System downloads appointment schedule, including customers' demographic information, mobile phone, address, etc
2. System checks data bases for previous history of customers
   a. The system has a previous record of a customer and some information about previous appointments. This could be answers to the questions, did the customer show up? Did the customer reschedule, was the customer late to the appointment?
   b. The system has no previous record of the customer
3. The system then sends reminders to the customer on a scheduled as follows
   a. If 2a applies, then the system has some specific history about the customer and tailors the reminder frequency and messaging to best target the specific customer. The targeting is based both on a customer's previous history as well as on trending data for the customer's specific demographic.
   b. If 2b applies, then the system uses general population trending data to send standard reminders
4. System recognizes responses by customers and takes action based on response, the customer can, for example:
   a. Confirm appointment
   b. Cancel appointment
   c. Reschedule an appointment
   d. No reply
   e. Request an appointment
   f. Ask a question
   g. Confirm an action
   h. Submit results
   i. Update location (e.g. with the device's GPS) (there can be various other customer communication options)
5. Depending on the responses in step 4, the system takes one or more of the following actions
   a. The system notifies the office, imaging center, etc of the customers who have confirmed, cancelled, or requested rescheduled appointments.
   b. The system manages a waitlist of customers and sends out offers for waitlist customers to fill now vacant spots that opened up due to cancelation.
   c. System decides based on customer's demographics or past history whether to reach out again and re-remind customers who did not reply within a prescribed time.
   d. The system alerts emergency service providers (e.g. if an elderly person did not check-in after repeated reminders, the system my alert the police).
   e. The system resends the reminder.
6. At least as often the end of each business day, and more often if specified, downloads data from the customer management system. The office manager/receptionist has entered whether or not each customer made his or her appointment. System then analyzes which customers made appointments how they were reminded and which customers missed appointment. The system can also uses outside sources such as weather emergency updates, accident reports, etc
   a. In preferred embodiments, the system can generate a message to reschedule a missed appointment or elicit another response.
7. Throughout this whole process the communication is captured at the customer level and the data is aggregated. The proprietary self teaching algorithms allow the system to recognize patterns in customer behavior and adjust the regimen and schedule of reminders for the future across all types of customers and appointment types (reminders for an imaging center appointment may be different than primary care reminders)

In preferred embodiments, information may be transmitted to groups, subgroups, categories, subcategories, or individuals. The groups, subgroups, categories, subcategories or individuals may be elected by the attendee or chosen by the registrant. Groups, subgroups, categories, and subcategories may include but are not limited to demographic groups, gender groups, sexual orientation groups, age groups, organizational groups, client groups, membership groups, disease groups, geographic groups, etc. The information transmitted may include, but is not limited to, health tips, beauty tips, thoughts of the day, coupons, sales, recurrent purchase reminders and the like.

### Examples

Example of system in use:

The hospital/clinic has a downloadable list of patient appointments. The server requests the appointment schedule for the next 7 business days.

The server takes the appointment schedule, integrate with SMS gateway (soundbite), and send SMS reminders to all the patients who have valid cell phone numbers. The SMS reminders go out 72 hours before the patient appointment. Example: Today is Monday February 22nd, The patients who have appointments on the Thursday the 25th get reminders. The TXT message might read, “Jon you have an appt with Dr. Gupta on Th. February 25 at 1030 AM reply Y to confirm N to cancel.”

The system also sends reminders to patients the morning of the appointment. Patients who have appointments on Tuesday the 23rd get a reminder the morning of the 23rd and give the location of the appointment.

The server also compiles a list of patients for whom invalid cell phones are on record, or who have no cell phone on record. This list is sent to the office manager of the client so as to request a cell phone number, so they can be enrolled in the SMS reminder program.

The system receives replies from patients, either to confirm or cancel the appointment.

There is delivery of a continuous email to the office manager with list of cancellations, confirmations, etc, as well as listing the patients who were not contacted.

The system keeps track of when the messages were sent out to each patient and if and when a patient replied. Thus the system tracks how long it took the patient to reply. The system recognizes and tracks the patients' response. The system also notes if no reply was made after 24 hrs and “flags it” or initiates a second reminder.

The system also downloads “data” for the previous seven days to track if a patient showed or not. From this the no show rate can be tracked. Three no-show rates, overall, no show rate for those reminded, no-show for those not sent SMS.

### Example of Self Learning System at Work

There are multiple levels by which the system learns the most effective way to target and remind customers. The first is at the general population level, demographics: The system, as it generates and stores data, can look and see the overall likelihood of a customer missing an appointment when the appointment was made six months previously vs. 3 weeks previously. The system can then look at Customer Anne and see that she made her appointment 5 months ago and that she is more likely to have forgotten her appointment. The system, through several regression models and historical data, can see that these customers are most likely to show up to an appointment if they are reminded a week in advance, then the system looks at Anne and remind her of her appointment a week ahead of schedule (the system takes in additional factors as well). The system has the ability to adjust the reminder strategy over time and test if there is an improvement in the likelihood of getting a customer to their appointment. Improvements lead to adoption by the system of the modified reminder strategy/schedule. Initially the default reminders schedule is set by the user, the system then has authority and schedules are determined through the self learning system.

Additionally the system looks at Anne's basic demographic and situation. Anne is a 48 year old female getting a mammogram and she lives 28 miles away from the imaging center. The system analyzes trends based on age, gender, type of test, distance, etc. Then choose a reminder schedule based on these trends.

The second level of self learning happens at the customer specific level: Let's say Anne has had several appointments in the records. She has missed appointments in the past. The system flags this and may make a more aggressive reminder schedule to ensure that Anne makes her appointment. The more appointments Anne has had the more accurate the information will be about Anne's specific behavior. The system adjusts the reminder schedule to reflect this data in balance with the overall data.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising” includes the terms “consisting of” and “consisting essentially of,” and the terms comprising, including, and containing are not intended to be limiting.

1. A method of automatically reminding an attendee of an appointment, comprising one or more computers implementing:
obtaining an appointment reference from a registrant;
predicting the likely behavior of the attendee, wherein the likely behavior of the attendee is based on at least one of past behavior of the attendee and compiled demographic behavior of multiple attendees;
transmitting at least one reminder to the attendee based on the predicted likely behavior of the attendee;
receiving a response from the attendee; and
notifying the registrant of the response received from the attendee.

2. The method of claim 1, wherein at least one of the transmitting and receiving is via at least one of a computer, e-mail, a land telephone, a cellular phone, a personal digital assistant (“PDA's”), a smartphone, or another portable device with communications capabilities.

3. The method of claim 1, further comprising maintaining information related to the attendee and the registrant in a secure and confidential format.

4. The method of claim 1, wherein the at least one reminder is transmitted to a designated group, subgroup, category, or subcategory.

5. The method of claim 4, wherein the attendee is given the option to opt into or opt out of the system and to determine the groups, subgroups, categories, or subcategories that the attendee wishes to be a part of.

6. The method of claim 1, wherein the response from the attendee is at least one of confirming the appointment, canceling the appointment, and rescheduling the appointment.

7. The method of claim 1, wherein the appointment is a time to take an action.

8. The method of claim 7, wherein the action is at least one of attending a meeting taking medication, taking a test, checking in with a service or office, or specified individual.

9. The method of claim 8, wherein the response is at least one of confirming medication was taken, test results, and location update.

10. The method of claim 9, wherein the location update is via a GPS application.

11. The method of claim 1, further comprising automatically generating a notification to a designated recipient in the event an expected response is not received.

12. The method of claim 1, further comprising storing all communications records, responses, or results, and demographic data to enable future documentation and analysis.

13. The method of claim 1, further comprising recording at least one of attendee or registrant preferences.

14. The method of claim 1, wherein the step of predicting the likely behavior of the attendee comprises at least one of predicting likelihood of missing an appointment, likelihood of being late to an appointment, and likelihood of rescheduling an appointment.

15. The method of claim 1, further comprising generating an automatic response to reschedule a missed appointment or elicit another response.

16. A system for automatically reminding an attendee of an appointment, comprising:
a processor;
a transceiver in communication with the processor; and
software executing on the processor, wherein the software:
obtains an appointment reference from a registrant;
predicts the likely behavior of the attendee, wherein the likely behavior of the attendee is based on at least one of past behavior of the attendee and compiled demographic behavior of multiple attendees;
transmits at least one reminder to the attendee based on the predicted likely behavior of the attendee;
receives a response from the attendee; and
notifies the registrant of the response received from the attendee.

17. The system of claim 16, wherein the transceiver at least one of transmit sand receives via at least one of a computer, e-mail, a land telephone, a cellular phone, a personal digital assistant (“PDA's”), a smartphone, or another portable device with communications capabilities.

18. The system of claim 16, wherein the software maintains information related to the attendee and the registrant in a secure and confidential format.

19. The system of claim 16, wherein the at least one reminder is transmitted to a designated group, subgroup, category, or subcategory.

20. The system of claim 19, wherein the attendee is given the option to opt into or opt out of the system and to determine the groups, subgroups, categories, or subcategories that the attendee wishes to be a part of.

21. The system of claim 16, wherein the response from the attendee is at least one of confirming the appointment, canceling the appointment, and rescheduling the appointment.

22. The system of claim 16, wherein the appointment is a time to take an action.

23. The system of claim 22, wherein the action is at least one of taking medication, taking a test, and checking in with a service.

24. The system of claim 23, wherein the response is at least one of confirming medication was taken, test results, and location update.

25. The system of claim 24, wherein the location update is via a GPS application.

26. The system of claim 16, wherein the software automatically generates a notification to a designated recipient in the event an expected response is not received.

27. The system of claim 16, wherein the software stores all communications records, responses, or results, and demographic data to enable future documentation and analysis.

28. The system of claim 16, wherein the software records at least one of attendee or registrant preferences.

29. The system of claim 16, wherein predicting the likely behavior of the attendee comprises at least one of predicting likelihood of missing an appointment, likelihood of being late to an appointment, and likelihood of rescheduling an appointment.

30. The system of claim 16, wherein the software generates an automatic response to reschedule a missed appointment or elicit another response.

31. A computer readable media for automatically reminding an attendee of an appointment, wherein the media causes a computer to:
obtain an appointment reference from a registrant;
predict the likely behavior of the attendee, wherein the likely behavior of the attendee is based on at least one of past behavior of the attendee and compiled demographic behavior of multiple attendees;
transmit at least one reminder to the attendee based on the predicted likely behavior of the attendee;
receive a response from the attendee; and
notify the registrant of the response received from the attendee.

32. The computer readable media of claim 32, where at least one of the transmitting and receiving is via at least one of a computer, e-mail, a land telephone, a cellular phone, a personal digital assistant (“PDA's”), a smartphone, or another portable device with communications capabilities.

33. The computer readable media of claim 32, wherein the media further causes the computer to maintain information related to the attendee and the registrant in a secure and confidential format.

34. The computer readable media of claim 32, wherein the at least one reminder is transmitted to a designated group, subgroup, category, or subcategory.

35. The computer readable media of claim 34, wherein the attendee is given the option to opt into or opt out of the system and to determine the groups, subgroups, categories, or subcategories that the attendee wishes to be a part of.

36. The computer readable media of claim 32, wherein the response from the attendee is at least one of confirming the appointment, canceling the appointment, and rescheduling the appointment.

37. The computer readable media of claim 32, wherein the appointment is a time to take an action.

38. The computer readable media of claim 37, wherein the action is at least one of taking medication, taking a test, and checking in with a service.

39. The computer readable media of claim 38, wherein the response is at least one of confirming medication was taken, test results, and location update.

40. The computer readable media of claim 39, wherein the location update is via a GPS application.

41. The computer readable media of claim 32, wherein the media further causes the computer to automatically generate a notification to a designated recipient in the event an expected response either is not received.

42. The computer readable media of claim 32, wherein the media further causes the computer to store all communications records, responses, or results, and demographic data to enable future documentation and analysis.

43. The computer readable media of claim 32, wherein the media further causes the computer to record at least one of attendee or registrant preferences.

44. The computer readable media of claim 32, wherein predicting the likely behavior of the attendee comprises at least one of predicting likelihood of missing an appointment, likelihood of being late to an appointment, and likelihood of rescheduling an appointment.

45. The computer readable media of claim 32, wherein the media further causes the computer to generate an automatic response to reschedule a missed appointment or elicit another response.
